(19) United States
(12) Patent Application Publication
(10) Pub. No.: US 2022/0281409 A1
(43) Pub. Date: Sep. 8, 2022

(54) ENHANCED AUTOMOTIVE ELECTRICAL BATTERY SYSTEM

(71) Applicants: Dana Bellah, Sanderson, TX (US); Thomas Julian Bellah, Sanderson, TX (US)

(72) Inventors: Dana Bellah, Sanderson, TX (US); Thomas Julian Bellah, Sanderson, TX (US)

(21) Appl. No.: 17/189,713

(22) Filed: Mar. 2, 2021

(51) Int. Cl. B60R 25/01; B60R 25/24; F02N 11/08; F02N 11/04; B60R 25/40; B60R 16/033; B60W 30/18; B60H 1/00

(52) U.S. Cl. CPC B60R 25/01; B60R 25/24; F02N 11/0859; F02N 11/04; B60R 25/40; B60R 16/033; F02N 11/0862; B60W 30/18127; B60H 1/00278

(57) ABSTRACT

An enhanced automotive electrical battery system having a primary automobile electrical energy source of an automobile having a combustion engine, a receiver configured to receive one or more wireless signals to respectively control one or more automobile functions, and a remote keyless entry (RKE) having a transmitter in wireless communication with the receiver and having one or more buttons. The remote keyless entry (RKE) is configured in an operating mode to transmit, via the transmitter, the one or more wireless signals to the receiver upon activation by the respective one or more buttons. Upon receipt of the one or more wireless signals by the receiver, one or more automobile functions are controlled without starting the combustion engine of the automobile.

### BACKGROUND OF THE INVENTION

### Field of the Invention

The present invention is generally related to batteries and automotive electrical systems, and more particularly to an enhanced automotive electrical battery system.

### Discussion of the Background

A conventional automotive SLI battery consists generally of six lead acid cells connected in series. It is a primary function of the automotive battery to provide sufficient high electric current at short intervals to crank the internal combustion engine in order that it may start. The battery must also provide current to the coil for engine ignition, and provides lighting, heating and ignition to the vehicle if the vehicle's generator is not operating. The current requirements of the starter motor are vastly different from those of the vehicle's auxiliaries, such as lighting, heating and ignition. Cranking requires large amounts of current for a relatively short duration as the start motor cranks the internal combustion engine against the compression of the cylinders. Whereas, ignition and other vehicle auxiliaries, however, require lower current rates but for longer periods of time. The conventional SLI battery system is therefore designed first to provide sufficient cranking power, and secondly to provide current to the vehicle's auxiliaries while the generator is not operating.

In addition, automobiles are designed to operate under a wide variety of temperature and weather conditions. However, the comfort of the driver and any passengers is often not taken into consideration with respect to these differing temperature and weather conditions. It is often desirable to start the heater or the air conditioner prior to the driver and any passengers entering the vehicle in order to make the vehicle interior more comfortable. It is known in the prior art to remotely start the engine of an automobile in order to warm the engine. Such a solution is deficient for numerous reasons. For instance, starting the engine of an automobile is dangerous due to the carbon dioxide emissions in a closed space such home garage or even a public covered parking lot or parking garage. There is also the possibility of a combustion engine overheating in a confined space potentially resulting in a fire or other hazard. Further, there is always the risk of theft of an untended automobile after the automobile is remotely started using techniques known in the prior art.

Thus, there currently exist deficiencies associated with automotive electrical systems, and, in particular, with an automotive electrical battery system.

### SUMMARY OF THE INVENTION

Accordingly, one aspect of the present invention is to provide an enhanced automotive electrical battery system having a primary automobile electrical energy source of an automobile having a combustion engine, a receiver configured to receive one or more wireless signals to respectively control one or more automobile functions, and a remote keyless entry (RKE) having a transmitter in wireless communication with the receiver and having one or more buttons. The remote keyless entry (RKE) is configured in an operating mode to transmit, via the transmitter, the one or more wireless signals to the receiver upon activation by the respective one or more buttons. Upon receipt of the one or more wireless signals by the receiver, one or more automobile functions are controlled without starting the combustion engine of the automobile.

Another aspect of the present invention is to provide an enhanced automotive electrical battery system having an electrical system connecting a plurality of automotive on-board systems of an automobile having a combustion engine, a primary automobile electrical energy source connected to the electrical system, a secondary automobile electrical energy source connected to the electrical system, a receiver connected to the electrical system and configured to receive one or more wireless signals to respectively control at least one of the plurality of automobile functions, and a remote keyless entry (RKE) having a transmitter in wireless communication with the receiver and having one or more buttons. A plurality of automobile functions control the plurality of automotive on-board systems of the automobile via signals communication via the electrical system. The remote keyless entry (RKE) is configured in an operating mode to transmit, via the transmitter, the one or more wireless signals to the receiver upon activation by the respective one or more buttons. Upon receipt of the one or more wireless signals by the receiver, one or more of the plurality of automobile functions are controlled without starting the combustion engine of the automobile, wherein the plurality of automobile functions include activating or deactivating one of the plurality of automotive on-board systems, wherein the one of the plurality of automotive on-board systems are powered by the secondary automobile electrical energy source.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIGS. 1A-1H are block diagrams illustrating an enhanced automotive electrical battery system in accordance with an embodiment of the present invention;

FIGS. 2A-2C are flow charts illustrating a method for an enhanced automotive electrical battery system in accordance with an embodiment of the present invention; and

FIGS. 3A-3C are exemplary graphical user interfaces for an enhanced automotive electrical battery system in accordance with an embodiment of the present invention.

### DETAILED DESCRIPTION OF THE PREFERRED EMBODIMENTS

Referring now to the drawings, wherein like reference numerals designate identical or corresponding parts throughout the several views, preferred embodiments of the present invention are described.

As used herein, a smart entry system is an electronic lock that controls access to a vehicle without using a traditional mechanical key. The term remote keyless system (RKS), also referred to as a remote keyless entry (RKE), refers to a lock that uses an electronic remote control key which is activated by a handheld device or automatically by proximity. Widely used in automobiles, an RKS performs the functions of a standard car key without physical contact. When within a few yards of the car, pressing a button on the remote can lock or unlock the doors, and may perform other functions.

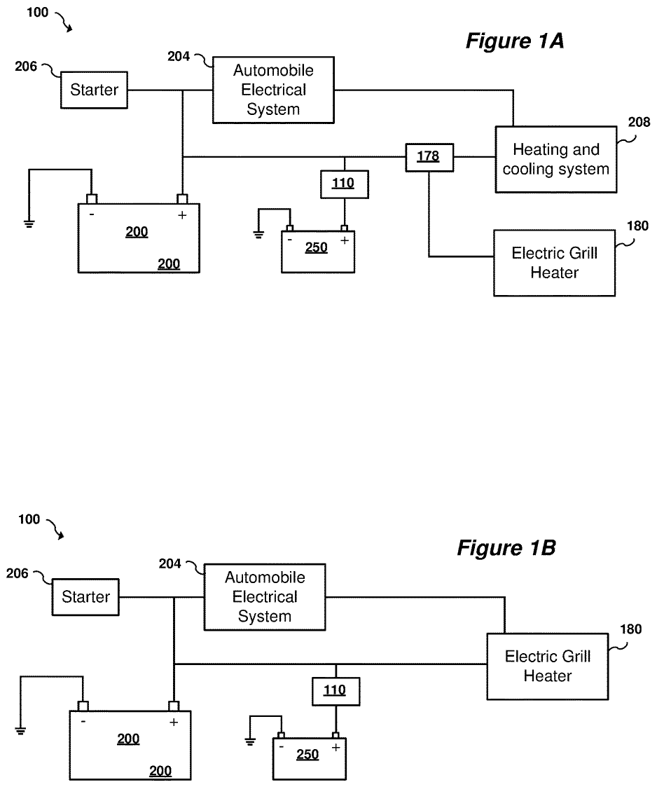

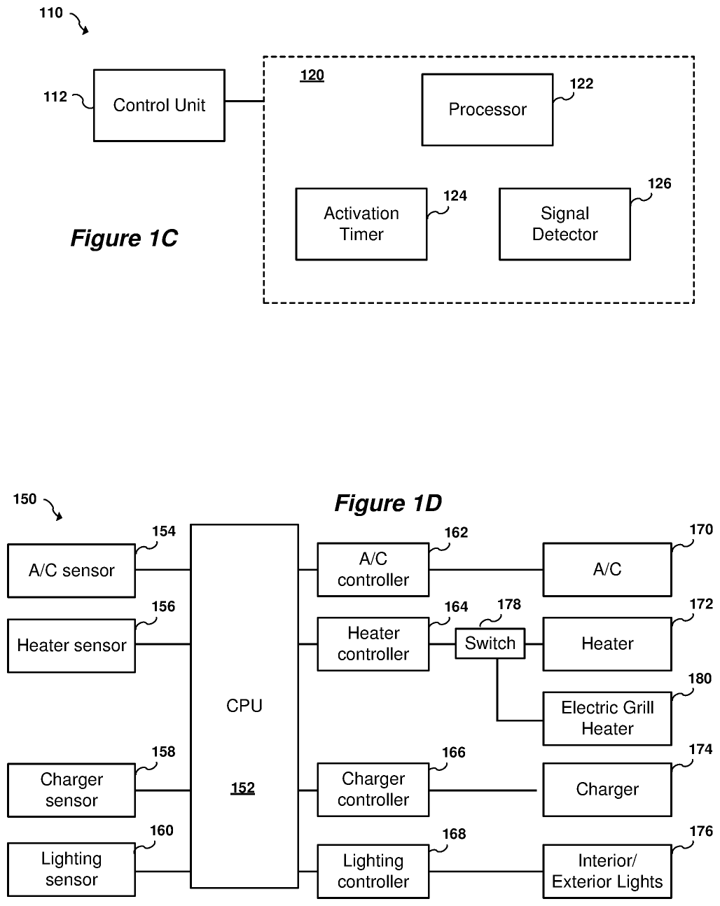

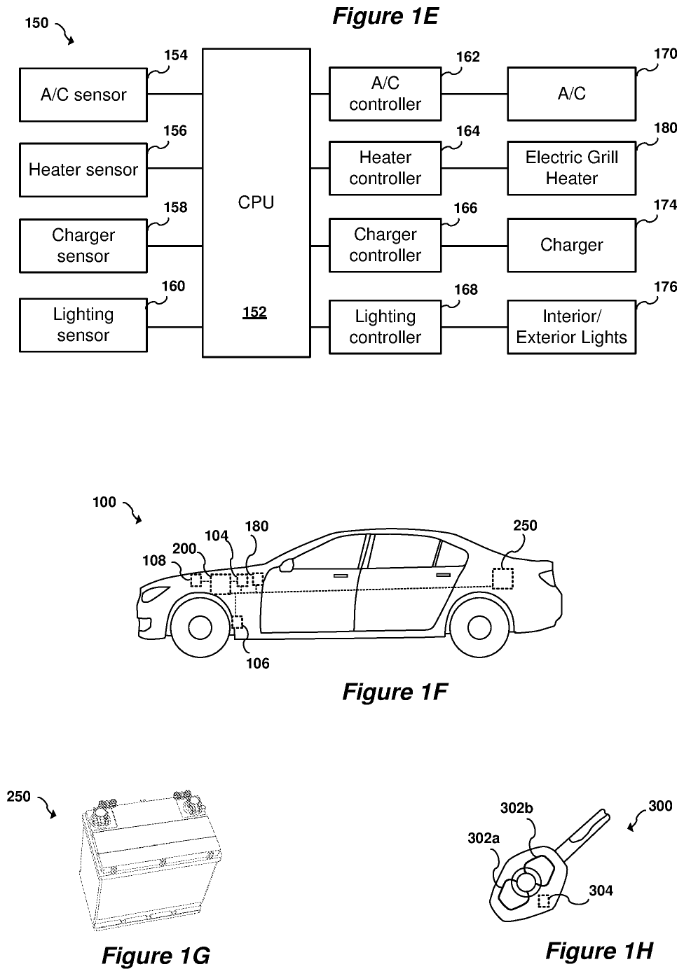

Referring to FIGS. 1A-1H, block diagrams illustrating a non-limiting exemplary of an enhanced automotive electrical battery system. According to an embodiment of the present invention, an automobile 100 includes a battery 200 in communication with an automobile electrical system 204, a receiver 104 in wireless communication with a remote keyless entry (RKE) 300, an electronic control unit 106, a heating and cooling system 208 and an ignition system (not shown). The electronic control unit 106 is connected to the different automotive on-board systems, and is configured to send or more signals to control the different automotive on-board systems, such as the heating system, the cooling system, the ignition system and the like.

According to an optional embodiment, the automobile 100 also includes a secondary battery 250 in communication with the automobile electrical system. Depending on the use for which it is intended, the secondary battery 250 can have the same electrical capacity or even a different, usually more limited, capacity compared to the battery 200 and, therefore, can be smaller and cheaper than the battery 200. Secondary battery 250 may be connected to the automobile electrical system through electronic switch 110.

According to an embodiment, the automobile 100 includes an electric grill heater 180 which is connected to the automobile electrical system through electronic switch 178,

The automobile 100 may also include an optional regenerative braking system 106 in communication with the automobile electrical system. According to this optional embodiment, upon braking, the kinetic energy of the automobile is converted into an electrical current using means known in the automobile industry as regenerative braking.

As shown in FIGS. 1C and 1D, the present invention includes control unit 112 in communication with a processor 122, an activation timer 124 and a signal detector 126. A CPU 152 is in communication with an A/C sensor 154, a heater sensor 156, a charger sensor 158 and a lighting sensor 160. Upon receiving a signal from A/C sensor 154, the CPU 152 may activate or deactivate A/C 170 through A/C controller 162. Upon receiving a signal from heater sensor 164, the CPU 152 may activate or deactivate heater 172 and/or electric grill heater 180 through heater controller 164. The activation or deactivation of heater 172 and/or electric grill heater 180 is by controlled by electronic switch 178. Upon receiving a signal from charger sensor 158, the CPU 152 may activate or deactivate charger 174 through charger controller 166. Upon receiving a signal from lighting sensor 160, the CPU 152 may activate or lighting charger 176 through lighting controller 168.

The remote keyless entry (RKE) 300 includes a transmitter 304 and one or more buttons 302a and 302b. Upon pressing one or more buttons 302a and 302b, the transmitter 304 transmits a signal to an automobile 100 within proximity of the remote keyless entry (RKE) 300.

### Processing Flows

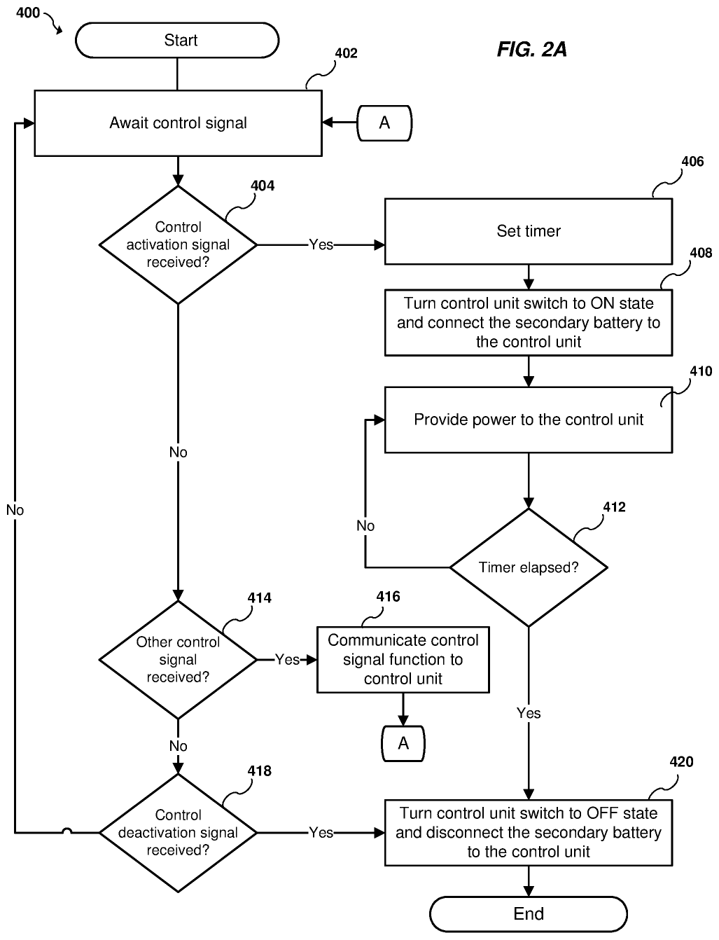

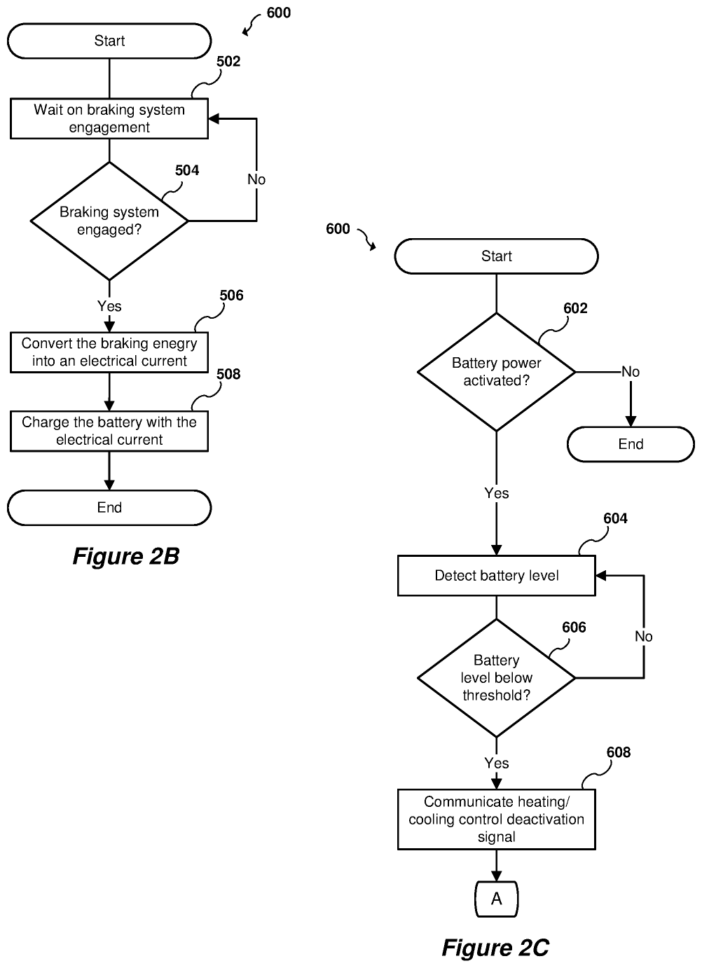

Referring to FIGS. 2A-2C, flow charts illustrating a method for an enhanced automobile electrical system in accordance with an embodiment of the present invention. At block 402, the present invention awaits one of a plurality of signals transmitted from a remote device via transmitter 254, such as a remote keyless entry (RKE). An automobile in proximity of, and in communication with, the RKE receives the respective signal via receiver 104 transmitted from the remote device. A determination is made at block 404 as to whether a control activation signal is received. If a control activation signal is received, then at block 406, a timer signal is set to automatically deactivate the respective automobile function after a predefined timeout. The control unit switch is set to on at block 408 and power is provided to the control unit ab block 410. Upon receive of a timeout signal, the respective automobile function is automatically deactivated, at block 420.

If a control activation signal is not received, then at block 414, a determination is made as to whether a control signal function was received. If a control signal was received, then the control signal function is communicated to the respective control unit. If a control signal function is not received, then at block 418, a determination is made as to whether a deactivation control signal was received. If a deactivation control signal was received, then the respective automobile function is automatically deactivated, at block 420.

An optional regenerative braking system 106 is illustrated in FIG. 2B. According to this embodiment, the braking system is engaged, at block 502. At block 506, upon engagement of the braking system, the kinetic energy of the automobile is converted into an electrical current using means known in the automobile industry as regenerative braking. The electrical current is communicated via the automobile's electrical system to the battery 200 and/or the secondary battery 250 to recharge the respective battery 200 and/or the secondary battery 250.

As shown in FIG. 2C, a determination of whether a battery power activated signal has been received is made at block 602. If a battery power activated signal has been received, then at block 604 the battery level is detected. If the battery level is below a predefined threshold at block 606, then a deactivation signal is automatically communicated at block 608.

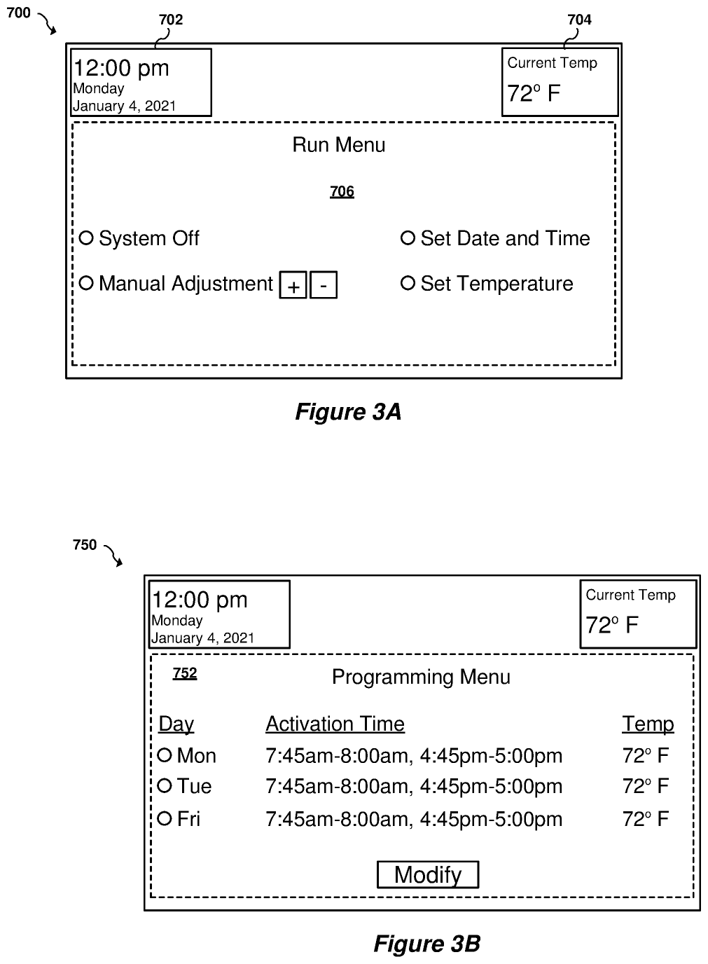

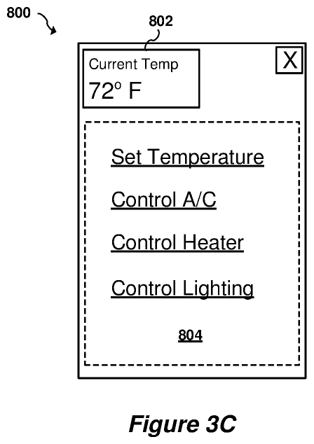

Referring to FIGS. 3A-3C, exemplary graphical user interfaces for an enhanced automotive electrical battery system in accordance with an embodiment of the present invention are shown. As shown the graphical user interfaces of the present invention provide the user without limitation the ability to remotely turn the system off or on, to perform manual adjustments, to set the date and time, and to set the temperature. As shown in FIG. 3B, the graphical user interface may also provide without limitation the ability to schedule the activation and/or deactivation times of a control system, such as the A/C system and/or heater grill. The user interface may be without limitation a mobile app or a desktop application.

The present invention may utilize one or more computer applications. As used herein, a “computer application” is a computer executable software application of any type that executes processing instructions on a computer or embedded in a processor, and an “application” or “application project” are the files, objects, structures, database resources and other resources used in integrating a computer application into a software platform.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

This invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, portions of the invention may be embodied as a method, device, or computer program product. Accordingly, portions of the present invention may take the form of an entirely hardware embodiment or an embodiment combining software and hardware aspects all generally referred to as a “circuit” or “module.”

The present invention includes a computer program product which may be hosted on a computer-usable storage medium having computer-usable program code embodied in the medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Computer program code for carrying out operations of the present invention may be written in any programming language including without limitation, object-oriented programming languages such as Java®, Smalltalk, C# or C++, conventional procedural programming languages such as the “C” programming language, visually oriented programming environments such as VisualBasic, and the like.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. An enhanced automotive electrical battery system, the system comprising:
a primary automobile electrical energy source of an automobile having a combustion engine;
a receiver configured to receive one or more wireless signals to respectively control one or more automobile functions;
a remote keyless entry (RKE) having a transmitter in wireless communication with the receiver and having one or more buttons, wherein the remote keyless entry (RKE) is configured in an operating mode to transmit, via the transmitter, the one or more wireless signals to the receiver upon activation by the respective one or more buttons; and
wherein, upon receipt of the one or more wireless signals by the receiver, one or more automobile functions are controlled without starting the combustion engine of the automobile.

2. The system of claim 1, wherein the system further comprises regenerative braking, in which in an operating mode a belt starter-generator is operated as an electrical generator recover kinetic energy of the automobile during braking and transform it into an electrical energy to recharge the primary automobile electrical energy source.

3. The system of claim 1, wherein one of the one or more wireless signals is transmitted upon a user pressing a respective one of the one or more buttons.

4. An enhanced automotive electrical battery system, the system comprising:
an electrical system connecting a plurality of automotive on-board systems of an automobile having a combustion engine, wherein a plurality of automobile functions control the plurality of automotive on-board systems of the automobile via signals communication via the electrical system;
a primary automobile electrical energy source connected to the electrical system;
a secondary automobile electrical energy source connected to the electrical system;
a receiver connected to the electrical system and configured to receive one or more wireless signals to respectively control at least one of the plurality of automobile functions;
a remote keyless entry (RKE) having a transmitter in wireless communication with the receiver and having one or more buttons, wherein the remote keyless entry (RKE) is configured in an operating mode to transmit, via the transmitter, the one or more wireless signals to the receiver upon activation by the respective one or more buttons; and
wherein, upon receipt of the one or more wireless signals by the receiver, one or more of the plurality of automobile functions are controlled without starting the combustion engine of the automobile, wherein the plurality of automobile functions include activating or deactivating one of the plurality of automotive on-board systems, wherein the one of the plurality of automotive on-board systems are powered by the secondary automobile electrical energy source.

5. The system of claim 4, wherein the plurality of automotive on-board systems comprise one selected from the group consisting of an automobile heating system and an automobile air conditioning system.

6. The system of claim 5, wherein, upon activation of one of the plurality of automotive on-board systems, a deactivation timer is initiated and configured to generate a deactivation signal after a predefined period of time, and wherein, upon receiving the deactivation signal, the activated one of the plurality of automotive on-board systems is automatically deactivated.

7. The system of claim 6, wherein the plurality of automotive on-board systems are powered by the secondary automobile electrical energy source only while the combustion engine of the automobile is off.
